(19) United States
(12) Patent Application Publication
(10) Pub. No.: US 2025/0330095 A1
(43) Pub. Date: Oct. 23, 2025

(54) DC-DC CONVERTER AND POWER SUPPLY SEMICONDUCTOR INTEGRATED CIRCUIT

(71) Applicant: Takehito MISHIMA, Atsugi-shi (JP)

(72) Inventor: Takehito MISHIMA, Atsugi-shi (JP)

(73) Assignee: MITSUMI ELECTRIC CO., LTD., Tokyo (JP)

(21) Appl. No.: 19/171,398

(22) Filed: Apr. 7, 2025

(30) Foreign Application Priority Data
Apr. 18, 2024 (JP) 2024-067165
Feb. 21, 2025 (JP) 2025-026323

(51) Int. Cl. H02M 3/158; B60L 53/22; H02M 1/32

(52) U.S. Cl. CPC H02M 3/1588; B60L 53/22; H02M 1/32; B60L 2210/10

(57) ABSTRACT

Disclosed is a DC-DC converter including: a first switch and second switch or rectifier in series between a voltage input terminal and a ground potential point; an inductor between the first switch and the second switch or rectifier; a control circuit controlling on/off of the first switch or the first and second switches according to feedback voltage of voltage output through the inductor, in which a third switch is connected between the voltage input terminal and the first switch, at least one first bypass capacitor is connected to the voltage input terminal, and a second bypass capacitor is connected to a second connection node between the first and third switches; and an abnormality detection circuit detecting short circuit of the second bypass capacitor by monitoring current in the first switch or voltage at the second connection node. The third switch turns off when short circuit is detected.

### REFERENCE TO RELATED APPLICATIONS

This application is based upon and claims the benefit of priority from the prior Japanese Patent Application No. 2024-067165, filed on Apr. 18, 2024 and Japanese Patent Application No. 2025-026323, filed on Feb. 21, 2025, the entire contents of which are incorporated herein by reference.

### TECHNICAL FIELD

This disclosure relates to a DC-DC converter and a power supply semiconductor integrated circuit (power supply IC) that convert and supply DC voltage, and relates to a technology that is effective for use in in-vehicle step-down DC-DC converters and power supply ICs to constitute them, for example.

### DESCRIPTION OF RELATED ART

There are in-vehicle power supply devices using DC-DC converters that step down DC voltage from the battery and output it (for example, JP-A-2019-205295). Some DC-DC converters use ICs (power supply ICs) incorporating a switching element connected between a voltage input terminal and a voltage output terminal and a control circuit that controls on/off of the switching element, and configured to convert the input voltage and output it by turning the switching element on and off.

A bypass capacitor is connected to the voltage input terminal of the power supply device or power supply IC connected to the battery to reduce noise in the power supply line and to suppress power supply fluctuations.

On the other hand, lead-acid batteries are generally used in batteries installed in vehicles (excluding electric vehicles), and surge countermeasures against power supply interruption are necessary. Here, the voltage of an in-vehicle battery using a lead-acid battery is usually 12 to 14 V. However, considering surge countermeasures, a bypass capacitor may require a withstand voltage of about 40 V.

In the past, surface-mount ceramic capacitors have generally been used as bypass capacitors in in-vehicle power supply devices. The cost and size of these surface-mount ceramic capacitors increase with higher withstand voltage and capacitance.

Furthermore, a technique is known to connect two ceramic capacitors in series to compensate for the withstand voltage of the bypass capacitor and as measures against short-circuit. This is because it is very unlikely that two capacitors will be short-circuited at the same time.

For example, in JP-A-2011-55634, a power supply device with two ceramic capacitors connected in series for short-circuit protection is shown in FIG. 1.

To constitute a bypass capacitor, two capacitors connected in series require a capacitance value that is twice the capacitance value of one capacitor. In the case of a single series connection, it is not possible to deal with open faults where the capacitors are disconnected. Therefore, as shown in FIG. 2, two series of two capacitors may be installed as bypass capacitors between the voltage input terminal VIN and the ground point of the power supply IC 10 that constitutes the DC-DC converter.

However, if two series of capacitors in series are installed as shown in FIG. 2, a total of four capacitors are required. Moreover, the original purpose of the bypass capacitor requires a large capacitance value of about 10 μF for each capacitor, which significantly increases the component cost and the mounting area. If the bypass capacitor is short-circuited, a large current may flow between the voltage input terminal VIN of IC 10 and the ground terminal GND, which may damage the IC.

In the above-mentioned JP-A-2011-55634, an invention is described in which a ceramic capacitor connected to the voltage input terminal of an IC prevents the overcurrent that flows when the capacitor is short-circuited, so that a series capacitor does not need to be installed as a bypass capacitor. However, this invention prevents overcurrent from flowing to the output terminal, which requires a resistor element for overcurrent detection and does not completely cut off the current supplied to the regulator in the subsequent stage.

### SUMMARY OF THE INVENTION

An object of the present disclosure is to provide a DC-DC converter and a power supply semiconductor integrated circuit that can reduce the number of large-capacity ceramic capacitors used in the bypass capacitor and the total capacitance value, thereby suppressing cost increase and mounting area increase.

Another object of the present disclosure is to provide a DC-DC converter and a power supply semiconductor integrated circuit that can prevent a large current from flowing and damaging electronic components in the event of a short circuit occurring in any of the ceramic capacitors constituting the bypass capacitor.

To achieve at least one of the abovementioned objects, according to an aspect of the present disclosure, there is provided a DC-DC converter comprising:
a first switch and a second switch or a rectifier connected in series between a voltage input terminal to which a DC voltage from a battery is input and a ground potential point;
an inductor having one terminal connected to a first connection node of the first switch and the second switch or the rectifier;
a control circuit that controls on/off of the first switch or the first switch and the second switch according to a feedback voltage of a voltage output through the inductor, wherein a voltage input to the voltage input terminal is converted and output, a third switch is connected between the voltage input terminal and the first switch, at least one capacitor constituting a first bypass capacitor is connected to the voltage input terminal, and one capacitor constituting a second bypass capacitor is connected to a second connection node between the first switch and the third switch; and
an abnormality detection circuit that detects whether or not the capacitor constituting the second bypass capacitor is short-circuited by monitoring a current flowing in the first switch or a voltage at the second connection node, wherein
the third switch turns off in response to the abnormality detection circuit detecting a short circuit in the capacitor constituting the second bypass capacitor.

### BRIEF DESCRIPTION OF DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a circuit configuration diagram showing an embodiment of a power supply IC to which the present disclosure is applied and an example of a DC-DC converter using the IC;

FIG. 2 is a circuit configuration diagram showing an example of a DC-DC converter using a conventional power supply IC; and

FIG. 3 is a circuit configuration diagram of a modification example of the DC-DC converter of the embodiment shown in FIG. 1.

### DETAILED DESCRIPTION

Hereinafter, one or more embodiments of the present disclosure will be described with reference to the drawings. However, the scope of the present disclosure is not limited to the disclosed embodiment(s).

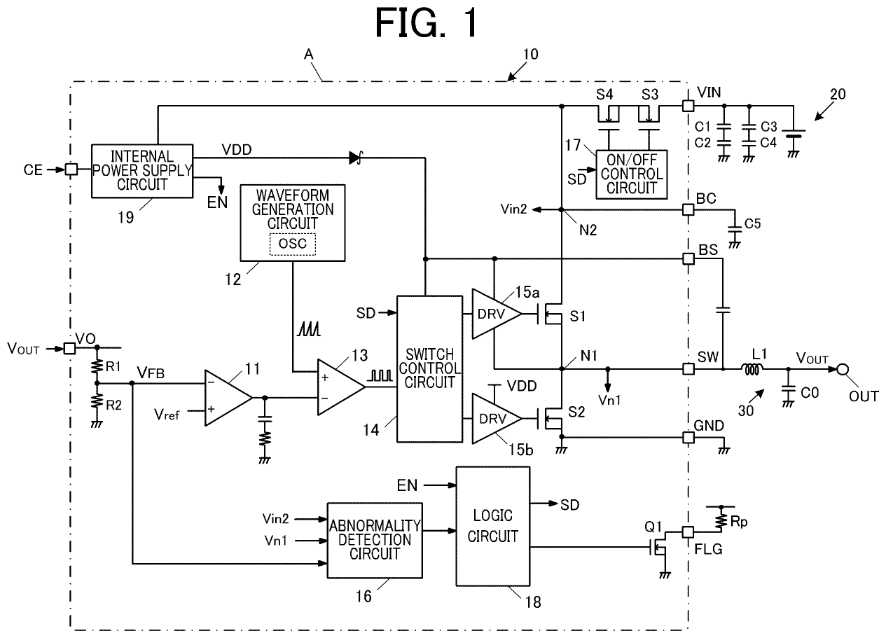

FIG. 1 shows a switching step-down DC-DC converter as an embodiment of the DC-DC converter of the present disclosure. In FIG. 1, the portion surrounded by a single dotted line A is formed as a semiconductor integrated circuit (power supply IC) 10 on a semiconductor chip such as single-crystal silicon. The DC-DC converter in the embodiment is a power supply device suitable for in-vehicle use where lead-acid batteries are used as batteries, and supplies power to in-vehicle loads such as electrical components and electronic devices installed in the vehicle, which are not shown in the drawings.

In the DC-DC converter of the embodiment shown in FIG. 1, a high-side switch S1 and a low-side switch S2 consisting of N-channel MOS transistors are provided in the power supply IC 10. A filter circuit 30 consisting of an inductor L1 and a capacitor C0 is connected to an external terminal SW connected to the connection node N1 of switches S1 and S2, and the external terminal SW is connected to the output terminal OUT through the filter circuit 30.

Two series capacitors C1, C2 and two series capacitors C3, C4 are connected in parallel as bypass capacitors between the voltage input terminal VIN, where DC voltage from a battery 20 is input, and the ground potential point. Here, ceramic capacitors with a high withstand voltage are used for capacitors C1, C2; C3, C4.

In addition, the power supply IC 10 has an external terminal BC for connecting the capacitor C5, which serves as a second bypass capacitor, in addition to the above capacitors C1 to C4.

In the power supply IC 10 of the embodiment, there is provided a circuit 17 in which switches S3 and S4 consisting of N-channel MOS transistors are connected in series between the voltage input terminal VIN and the high-side switch S1, and signals to control on/off of these switches S3 and S4 are generated.

Here, the two switches S3 and S4 are connected in series to prevent current flow in the opposite direction through the diodes parasitic on the base of the MOS transistors of the above switches S3 and S4 when the voltage at the voltage input terminal VIN becomes relatively lower than the voltage at the output terminal OUT while the switches S3 and S4 are turned off. In other words, the MOS transistors constituting switches S3 and S4 are connected so that the respective parasitic diodes are in opposite directions. The switches S3 and S4 may in principle be a single switch.

Here, when the above switches S3 and S4 are turned on, the capacitor C5 connected to the external terminal BC is in parallel with the capacitors C1, C2; C3, C4 connected to the voltage input terminal VIN, and thus functions as a second bypass capacitor. Therefore, in the embodiment, a ceramic capacitor with a high withstand voltage is also used for the capacitor C5. However, the capacitance value of capacitor C5 of the second bypass capacitor can be different from that of capacitors C1 to C4 of the first bypass capacitor.

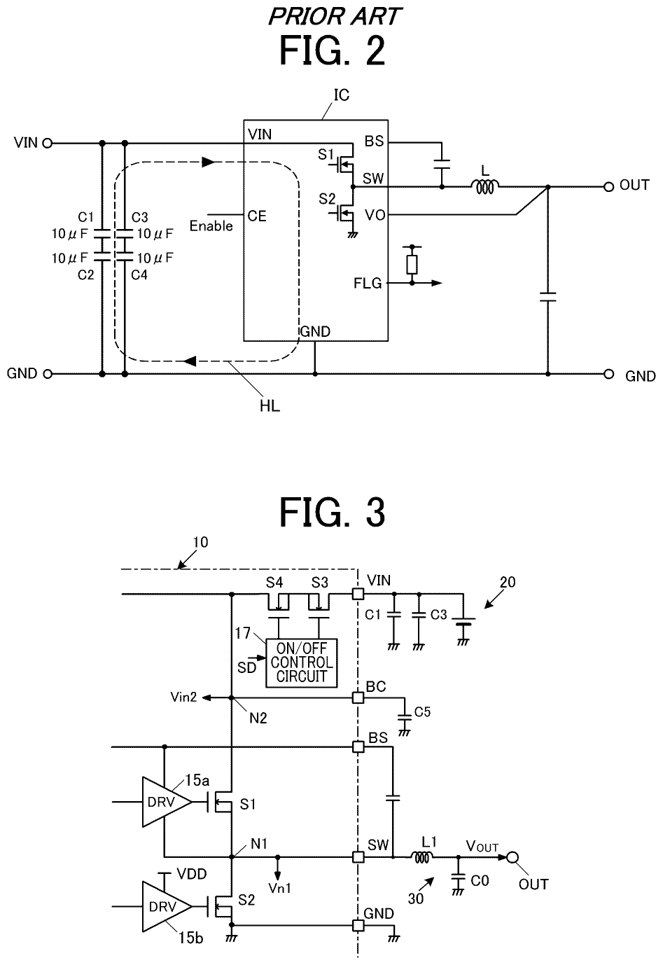

Specifically, in a case where a bypass capacitor with the same characteristics as the bypass capacitor consisting of the four capacitors C1 to C4 in the conventional DC-DC converter shown in FIG. 2 is to be realized in the DC-DC converter of the embodiment, when the capacitance value of each of the four capacitors C1 to C4 is set to 10 μF in the DC-DC converter shown in FIG. 2, the capacitance value of each of the four capacitors C1 to C4 may be set to 1 μF if the capacitance value of capacitor C5 is set to 10 μF in the DC-DC converter of the embodiment.

In the semiconductor market at the time of filing, 1 μF capacitors are available for less than one-tenth the price of 10 μF capacitors. Therefore, in the case of DC-DC converter of the embodiment, though the number of capacitors used increases by one compared to the conventional one (FIG. 2), the total cost can be reduced to about one-third. The size of a 1 μF capacitor is much smaller than that of a 10 μF capacitor. Thus, the mounting area as a whole bypass capacitor (C1 to C5) can also be reduced.

Furthermore, the use of two series capacitors as bypass capacitors is for short-circuit protection to avoid continued high current flow in the event of a capacitor short circuit, as mentioned above. In the power supply IC 10 of the embodiment, the switches S3 and S4 are provided between the voltage input terminal VIN and the high-side switch S1. When the capacitor C5, which is connected to the external terminal BC, is short-circuited, if the switches S3 and S4 are turned off, there is no need to connect two bypass capacitors in series.

And by using a single stage instead of two capacitors in series like the capacitor C5, the impedance between the external terminal BC and the ground potential point can be reduced due to the capacitor's internal ESR (equivalent series resistance). As a result, a power supply IC with a hot loop of good characteristics can be realized, which improves the stability of IC operation and reduces high-frequency noise.

Next, the configuration of the power supply IC 10 in the embodiment, including the circuit that controls the on/off of the switches S3 and S4 connected between the voltage input terminal VIN and the high-side switch S1, is described.

As shown in FIG. 1, the power supply IC 10 in this embodiment includes: an external terminal VO to which the output voltage Vout is input; an error amplifier 11 that amplifies the potential difference between feedback voltage VFB divided by resistors R1 and R2 connected in series between the terminal VO and the ground terminal GND and a predetermined reference voltage Vref; a waveform generation circuit 12 that includes an oscillation circuit OSC and generates a triangular wave (saw wave) of a predetermined frequency; and a PWM comparator 13 that takes the waveform signal generated by the waveform generation circuit 12 and the output of the above error amplifier 11 as inputs.

The control IC 10 also includes: a switch control circuit (SW control circuit) 14 that generates control signals to control the on/off of the high-side switch S1 and low-side switch S2 based on the output of the above PWM comparator 13; and drive circuits (driver DRVs) 15a and 15b that generate and output on/off drive signals for the switches S1 and S2 according to the on/off control signals generated by the switch control circuit 14.

In addition, the control IC 10 further includes: an abnormality detection circuit 16 that detects an abnormal state such as a short circuit of the capacitor C5 connected to the external terminal BC described above; an on/off control circuit 17 for short-circuit detection that generates signals to control the on/off of the switches S3 and S4 connected between the voltage input terminal VIN and the high-side switch S1; a logic circuit 18 that generates short-circuit detection signals and the like to the on/off control circuit 17 based on abnormality detection signal by the abnormality detection circuit 16; and an internal power supply circuit 19 consisting of a linear regulator such as a series regulator that generates internal power supply voltage VDD (for example, 5 V) for the operation of the internal circuits of the IC based on the battery voltage input to the voltage input terminal VIN.

The control IC 10 also includes an external terminal CE to which a chip enable signal is input to instruct on/off the IC, which is supplied from an external CPU, and the like. The internal power supply circuit 19 operates according to the state of the external terminal CE and also generates the enable signal EN and supplies it to the above logic circuit 18, and the like.

The abnormality detection circuit 16 is configured to detect a short-circuit state in the capacitor C5 by monitoring the voltage Vin2 at the connection node N2 between the switch S4 and the high-side switch S1 or the current flowing in the high-side switch S1.

For example, when the capacitor C5 is short-circuited, the current flowing in the hot loop through the capacitor C5 and the high-side switch S1 increases. Therefore, by setting up an amplifier for current detection with the drain voltage of the high-side switch S1 (voltage Vin2 of the connection node N2) and the source voltage (voltage Vn1 of the connection node N1) as inputs, when the current flowing in the high-side switch S1 increases to or above a predetermined level, it can be determined that the capacitor C5 is short-circuited. Alternatively, when the capacitor C5 is short-circuited, the current increases and the voltage Vin2 of connection node N2 decreases. Thus, when the voltage Vin2 falls to or below a predetermined potential, it is determined that the capacitor C5 is short-circuited. Furthermore, both the current flowing in the high-side switch S1 and the voltage Vin2 of the connection node N2 may be monitored to determine that the capacitor C5 is short-circuited.

The abnormality detection circuit 16 has the function of detecting abnormal states such as overvoltage and low voltage at the output based on the feedback voltage VFB divided by the resistors R1 and R2 connected to the external terminal VO. The low-voltage state of the output may be detected by directly monitoring the voltage at the external terminal VO.

In addition, the control IC 10 includes an external terminal FLG for outputting an abnormality flag signal to inform the outside of the IC that an abnormality has been detected, and an open-drain N-channel MOS transistor Q1 connected to the terminal FLG.

When the abnormality detection circuit 16 detects a short-circuit state in the capacitor C5, the logic circuit 18 generates a short-circuit detection signal SD and supplies it to the above on/off control circuit 17. The on/off control circuit 17 turns off the switches S3 and S4 upon receiving the short-circuit detection signal SD.

When the abnormality detection circuit 16 detects the short-circuit state in the capacitor C5, it turns on the transistor Q1 connected to the external terminal FLG. The abnormality detection circuit 16 has the function of taking the logical OR of multiple abnormality detection results, which is not particularly limited, and also turns on the above transistor Q1 when it detects an abnormal state such as overvoltage or low voltage at the output.

A pull-up resistor Rp is connected to the signal line connected to the external terminal FLG above. When the transistor Q1 is turned on, current flows through the pull-up resistor Rp and the voltage on the signal line drops, allowing external devices to know that an abnormality has occurred in the control IC 10.

The short-circuit detection signal SD generated by the logic circuit 18 is also supplied to the switch control circuit 14, which is configured to stop on/off control of the high-side switch S1 and the low-side switch S2 upon receiving the short-circuit detection signal SD.

The above abnormality detection circuit 16 may include a temperature detection element to have a function to detect that the chip temperature of the IC has risen to or above a predetermined value or have a function to detect an overcurrent, so that IC operation can be stopped when an abnormal chip temperature or overcurrent is detected. In order to notify the outside that these abnormalities have been detected, the power supply IC 10 may be configured with multiple external terminals FLG for outputting the abnormal flag signals, so that the type of abnormality can be distinguished and output.

In addition, the power supply IC 10 may include a soft-start circuit that suppresses inrush current at startup to prevent overshooting of the output voltage.

In the above embodiment, two sets of two bypass capacitors in series C1, C2; C3, C4 are connected to the voltage input terminal VIN as a short-circuit measure for capacitors, but by providing a separate short-circuit measure, two parallel bypass capacitors C1 and C3 may be connected to the voltage input terminal VIN as shown in FIG. 3. As described in JP-A-2011-55634, for example, there are known technologies as measures against short circuit for bypass capacitors that provide means to detect current such as a sense resistor and means to limit or cut off current when an abnormal current caused by a capacitor short-circuit is detected. It is conceivable to use such a technology.

As for the bypass capacitor connected to the voltage input terminal VIN, a system that allows the bypass capacitor to be disconnected is also possible, since the basic operation of the DC-DC converter is not affected even if the capacitor is disconnected from the terminal. Therefore, the bypass capacitor connected to the voltage input terminal VIN can be a set of two capacitors in series (C1, C2 or C3, C4) or only one capacitor (C1 or C3). Even when the bypass capacitor is a set of two capacitors in series or only one capacitor, the capacitance value of the bypass capacitor connected to the voltage input terminal VIN can be reduced by providing a second bypass capacitor C5 and setting its capacitance value high.

Although certain aspects of the present disclosure have been specifically described above based on the embodiments, the present disclosure is not limited to the above embodiments. For example, in the above embodiment, the present disclosure is applied to a synchronous rectification DC-DC converter with a high-side switch and a low-side switch, but it can also be applied to a DC-DC converter using a diode instead of the low-side switch and a power supply IC constituting the same. Furthermore, it is not limited to the switching type DC-DC converter, but can be applied to a DC-DC converter such as a linear regulator and a power supply IC constituting the same.

In the above embodiment, the high-side switch S1 and the low-side switch S2 are composed of on-chip elements, but discrete transistors may be used for these elements. Similarly, the switches S3 and S4 connected between the voltage input terminal VIN and the high-side switch S1 may also use external discrete transistors. In such a case, the power supply IC 10 may be provided with a terminal to output the on/off control signals of the switches S3 and S4 generated by the on/off control circuit 17 to the outside.

Furthermore, in the above embodiment, the function of the power supply IC 10 is realized by a single IC, but it can be configured by multiple ICs or electronic components.

According to the DC-DC converter having the above configuration, by having a second bypass capacitor consisting of one capacitor in addition to the first bypass capacitor consisting of at least one capacitor, it is possible to reduce the capacitance value of the ceramic capacitor that constitutes the first bypass capacitor, thereby reducing the number of large-capacity ceramic capacitors used and the total capacitance value, and reducing the cost increase and the mounting area increase.

The second bypass capacitor is composed of a single capacitor, but a switch is provided between the voltage input terminal and the transistor for output, and this switch is turned off when a short circuit of the second bypass capacitor is detected. This prevents a large current from flowing and damaging the components of the DC-DC converter even if the second bypass capacitor is short-circuited. On the other hand, the first bypass capacitor is composed of series capacitors as measures against short-circuit. Thus, even if one of the capacitors is short-circuited, a large current will not flow.

Furthermore, since the second bypass capacitor can be composed of a single ceramic capacitor, the internal ESR (equivalent series resistance) of the capacitor is smaller than that of two capacitors in series when the part other than the bypass capacitor is composed as an IC. This reduces the impedance of the hot loop through the second bypass capacitor and the first switch in the IC, which improves the stability of the IC operation and reduces high-frequency noise coming from the power supply line connected to the battery.

According to the DC-DC converter and power supply IC of the above embodiment, the number of large-capacity ceramic capacitors used in the bypass capacitor and the total capacitance value can be reduced, thereby suppressing the cost increase. There is also an effect of preventing electronic components from being damaged by a large current flow in the event of a short circuit in any of the ceramic capacitors that constitute the bypass capacitor.

Although some embodiments of the present disclosure have been described and illustrated in detail, the disclosed embodiments are made for purposes of not limitation but illustration and example only. The scope of the present disclosure should be interpreted by terms of the appended claims.

1. A DC-DC converter comprising:
a first switch and a second switch or a rectifier connected in series between a voltage input terminal to which a DC voltage from a battery is input and a ground potential point;
an inductor having one terminal connected to a first connection node of the first switch and the second switch or the rectifier;
a control circuit that controls on/off of the first switch or the first switch and the second switch according to a feedback voltage of a voltage output through the inductor, wherein a voltage input to the voltage input terminal is converted and output, a third switch is connected between the voltage input terminal and the first switch, at least one capacitor constituting a first bypass capacitor is connected to the voltage input terminal, and one capacitor constituting a second bypass capacitor is connected to a second connection node between the first switch and the third switch; and
an abnormality detection circuit that detects whether or not the capacitor constituting the second bypass capacitor is short-circuited by monitoring a current flowing in the first switch or a voltage at the second connection node, wherein
the third switch turns off in response to the abnormality detection circuit detecting a short circuit in the capacitor constituting the second bypass capacitor.

2. The DC-DC converter according to claim 1, wherein
the battery is a lead-acid battery installed in a vehicle, and
the voltage input to the voltage input terminal and converted is supplied to an in-vehicle load.

3. A power supply semiconductor integrated circuit comprising:
a voltage input terminal to which a DC voltage from a battery is input;
a first external terminal to which one terminal of an external inductor is connected;
a ground terminal to which a ground potential is applied;
a second external terminal to which a voltage output through the inductor is input;
a first switch connected between the voltage input terminal and the first external terminal;
a second switch or a rectifier connected between the first external terminal and the ground terminal;
a control circuit that controls on/off of the first switch or the first switch and the second switch according to a feedback voltage of the voltage input to the second external terminal;
a third switch connected between the voltage input terminal and the first switch;
a third external terminal connected to a connection node between the third switch and the first switch, to which one terminal of a capacitor that is externally located is connected; and
an abnormality detection circuit that detects whether or not the capacitor connected to the third external terminal is short-circuited by monitoring a current flowing in the first switch or a voltage at the connection node, wherein
the third switch turns off in response to the abnormality detection circuit detecting a short circuit in the capacitor.

4. The power supply semiconductor integrated circuit according to claim 3, wherein
the third switch includes two MOS transistors connected in series, and
the two MOS transistors are each connected so that parasitic diodes face in opposite directions.

5. A DC-DC converter comprising:
the power supply semiconductor integrated circuit according to claim 3;
an inductor located externally and having one terminal connected to the first external terminal and another terminal connected to an output terminal;
a first bypass capacitor including at least one ceramic capacitor located externally and connected in series between the voltage input terminal and a ground potential point; and
a second bypass capacitor including at least one ceramic capacitor located externally and connected between the third external terminal and a ground potential point.

6. The DC-DC converter according to claim 5, wherein the first bypass capacitor includes a plurality of pairs of ceramic capacitors in series, the plurality of pairs being connected in parallel.
